(19) United States
(12) Patent Application Publication
(10) Pub. No.: US 2026/0050443 A1
(43) Pub. Date: Feb. 19, 2026

(54) PREDICTING AN OUTCOME OF A BRANCH INSTRUCTION

(71) Applicant: Arm Limited, Cambridge (GB)

(72) Inventors: Houdhaifa BOUZGUARROU, Austin, TX (US); Rami Mohammad AL SHEIKH, Morrisville, NC (US); Alexander Cole SHULYAK, Austin, TX (US)

(21) Appl. No.: 18/802,072

(22) Filed: Aug. 13, 2024

(51) Int. Cl. G06F 9/38; G06F 9/30

(52) U.S. Cl. CPC G06F 9/3806; G06F 9/30058

(57) ABSTRACT

There is provided an apparatus comprising processing circuitry to perform processing operations. The processing circuitry is responsive to a branch instruction to determine whether a condition associated with the branch instruction is satisfied and, if so, to trigger a non-sequential change in the processing operations to an instruction at a target address. The apparatus is provided with control circuitry to identify when an occurrence of the branch instruction is a data dependent occurrence in which the condition has a dependency on a data value, the dependency satisfying a predetermined condition. The apparatus is provided with pre-computation circuitry to perform tracking operations to track the data value and to perform a determination, in advance of execution of the branch instruction, of whether the condition will be satisfied. The apparatus is provided with prediction circuitry to perform a data dependent prediction of an outcome of the branch instruction in dependence on the determination.

### TECHNICAL FIELD

The present invention relates to data processing. More particularly the present invention relates to an apparatus, a system, a chip containing product, a method, and a computer-readable medium.

### BACKGROUND

Some apparatuses are responsive to branch instructions specifying a target address to cause instruction execution to jump to that target address in response to a condition being satisfied.

### SUMMARY

According to a first aspect of the present techniques there is provided an apparatus comprising:
processing circuitry configured to perform processing operations in response to a sequence of instructions, wherein the processing circuitry is responsive to a branch instruction to determine whether a condition associated with the branch instruction is satisfied and, in response to the condition being satisfied, to trigger a non-sequential change in the processing operations to an instruction at a target address;
control circuitry configured to identify when an occurrence of the branch instruction is a data dependent occurrence of the branch instruction in which the condition has a dependency on a data value, the dependency satisfying a predetermined condition;
pre-computation circuitry configured to perform one or more tracking operations to track the data value and to perform a determination, in advance of execution of the branch instruction, of whether the condition will be satisfied; and
prediction circuitry configured to perform a data dependent prediction of an outcome of the branch instruction in dependence on the determination.

According to a second aspect of the present techniques there is provided a system comprising:
the apparatus according to the first aspect, implemented in at least one packaged chip;
at least one system component; and
a board,
wherein the at least one packaged chip and the at least one system component are assembled on the board.

According to a third aspect of the present techniques there is provided a chip-containing product comprising the system according to the third aspect, wherein the system is assembled on a further board with at least one other product component.

According to a fourth aspect of the present techniques there is provided a method comprising:
performing processing operations in response to a sequence of instructions;
in response to a branch instruction, determining whether a condition associated with the branch instruction is satisfied;
in response to the condition being satisfied, triggering a non-sequential change in the processing operations to an instruction at a target address;
identifying when an occurrence of the branch instruction a data dependent occurrence of the branch instruction in which the condition has a dependency on a data value, the dependency satisfying a predetermined condition;
performing one or more tracking operations to track the data value and performing a determination, in advance of execution of the branch instruction, whether the condition will be satisfied; and
performing a data dependent prediction of an outcome of the branch instruction in dependence on the determination.

According to a fifth aspect of the present techniques there is provided a non-transitory computer-readable medium storing computer-readable code for fabrication of an apparatus comprising:
processing circuitry configured to perform processing operations in response to a sequence of instructions, wherein the processing circuitry is responsive to a branch instruction to determine whether a condition associated with the branch instruction is satisfied and, in response to the condition being satisfied, to trigger a non-sequential change in the processing operations to an instruction at a target address;
control circuitry configured to identify when an occurrence of the branch instruction is a data dependent occurrence of the branch instruction in which the condition has a dependency on a data value, the dependency satisfying a predetermined condition;
pre-computation circuitry configured to perform one or more tracking operations to track the data value and to perform a determination, in advance of execution of the branch instruction, of whether the condition will be satisfied; and
prediction circuitry configured to perform a data dependent prediction of an outcome of the branch instruction in dependence on the determination.

### BRIEF DESCRIPTION OF THE DRAWINGS

The present invention will be described further, by way of example only, with reference to configurations thereof as illustrated in the accompanying drawings, in which:

FIG. 1 schematically illustrates an apparatus according to some configurations of the present techniques;

FIG. 2 schematically illustrates an apparatus according to some configurations of the present techniques;

FIG. 3 schematically illustrates an apparatus according to some configurations of the present techniques;

FIG. 4 schematically illustrates an apparatus according to some configurations of the present techniques;

FIG. 5 schematically illustrates an apparatus according to some configurations of the present techniques;

FIG. 6 schematically illustrates an apparatus according to some configurations of the present techniques;

FIG. 7 schematically illustrates an apparatus according to some configurations of the present techniques;

FIG. 8 schematically illustrates pre-computation circuitry according to some configurations of the present techniques;

FIG. 9 schematically illustrates a sequence of steps carried out according to some configurations of the present techniques;

FIG. 10 schematically illustrates a sequence of steps carried out according to some configurations of the present techniques; and

FIG. 11 schematically illustrates a system and a chip containing product according to some configurations of the present techniques.

### DESCRIPTION OF EXAMPLE CONFIGURATIONS

Before discussing the configurations with reference to the accompanying figures, the following description of configurations is provided.

According to some configurations of the present techniques there is provided an apparatus comprising processing circuitry configured to perform processing operations in response to a sequence of instructions. The processing circuitry is responsive to a branch instruction to determine whether a condition associated with the branch instruction is satisfied and, in response to the condition being satisfied, to trigger a non-sequential change in the processing operations to an instruction at a target address. The apparatus is also provided with control circuitry configured to identify when an occurrence of the branch instruction is a data dependent occurrence of the branch instruction in which the condition has a dependency on a data value, the dependency satisfying a predetermined condition. The apparatus is also provided with pre-computation circuitry configured to perform one or more tracking operations to track the data value and to perform a determination, in advance of execution of the branch instruction, of whether the condition will be satisfied. The apparatus is also provided with prediction circuitry configured to perform a data dependent prediction of an outcome of the branch instruction in dependence on the determination.

Branch instructions may be provided as part of a set of instructions defined in an instruction set architecture. Such branch instructions may be inserted into a sequence of instructions by a programmer or compiler to cause execution of the sequence of instructions to a target address which may be specified in the branch instruction. The branch instruction therefore enables a sequence of instructions be executed non-concurrently. Whilst some branch instructions are non-conditional branch instructions that cause instruction execution to jump unconditionally to the target address, some branch instructions are conditional enabling the flow of instructions to be dependent on a particular value stored in a register, e.g., a conditional flag stored in a conditional register which may be set based on a comparison or other operation based on data values stored in one or more general purpose registers. The provision of such instructions allows a compiler or programmer to implement conditional statements and/or loops in program code.

The inclusion of a branch instruction in a sequence of instructions means that it is generally not known, until that instruction is executed, which instruction will follow the branch instruction. As a result, the processing circuitry may have to wait whilst the instructions are fetched from memory. Speculative structures, e.g., prediction structures may be provided to predict when branches will occur and what the target address will be, and a result of those branches, e.g., whether the branch is taken or not taken. These structures can be implemented based on historical data in which historical information (for example, locations of previous branches and/or whether a previous one or more branches were taken or not taken). However, the inventors have recognised that there are some use cases in which history based predictors may not perform well. In particular, when a branch instruction is dependent on a data value either stored in an array which, for example, may contain either random data or data for which the branch prediction structure is unable to recognise a pattern, history based branch predictors will perform poorly.

The apparatus is provided with control circuitry that is configured to recognise occurrences of such data dependent occurrences of the branch instruction. Whilst, in general, any branch instruction will be data dependent, the control circuitry is arranged to look for branch instructions that have a data dependency on a data value where the dependency satisfies a predetermined condition. For example, the predetermined condition may be met when the branch instruction is preceded by a load instruction to load a value into a data register and a branch control flag (determining whether the branch will be taken or not taken) is dependent on the data value in the register. For example, if data stored at a location is continually updated to a random (i.e., an unpredictable value), and a branch instruction is based on a result of loading the data from the location and determining whether it falls one side of a threshold or the other, then from the point of view of the history based predictor, whether the branch is taken or not taken is equally random and any agreement between a history based prediction and whether the branch is actually taken is purely coincidental. Further examples of predetermined conditions that may be implemented are described below.

Rather than making exclusive use of a history based predictor, the apparatus is provided with pre-computation circuitry that is configured to track the data value. In particular, once a data dependent occurrence of the branch instruction has been identified, the pre-computation circuitry may monitor the address at which the data value is stored in advance of the branch instruction to determine, based on the current data value (either estimated or dependent on a current actual value), an outcome of the condition, i.e., whether the condition associated with the branch instruction would be satisfied based on the monitored data value. The apparatus is further provided with prediction circuitry that is responsive to receipt of the data dependent prediction to predict the outcome of the branch instruction. By performing the one or more tracking operations on the data value, the prediction can be made as a data dependent prediction. The data dependent prediction may be the only prediction or it may be provided in addition to a history dependent prediction (as will be discussed in further detail below). For some use cases, the accuracy of the data dependent prediction will exceed the accuracy of any history dependent predictions and can be used as a basis for predicting the instructions that need to be retrieved for future execution. Hence, the present techniques provide an apparatus that is able to more accurately predict the outcome of branch instructions in use cases where the branch condition has a data dependency and the data dependency satisfies a predetermined condition. This, in turn results in a reduced latency associated with retrieving instructions required by the processing circuitry subsequent to the branch instruction.

The data dependency may be variously defined. However, in some configurations the control circuitry is configured to identify that the predetermined condition is satisfied based on an observation that the data value is dependent on a load instruction preceding the data dependent occurrence of the branch instruction. The dependency on the load instruction may immediately precede the branch instruction, e.g., the load instruction, the comparison based on the load instruction, and the branch instruction may be consecutive instructions. In some configurations the load instruction and the branch instruction may be comprised in a same block of instructions. However, in general this does not have to be the case. In some configurations one or more additional instructions may be present between any of the load instruction, the comparison instruction and the branch instruction. For example, the predetermined condition may be determined to be satisfied by tracking when a loaded data value is directly used to set a branch flag. Here a loaded value is considered to be directly used if that loaded value is stored in a register (e.g., a general purpose register) and, subsequently, the value in that register is used (without being further modified) in a comparison instruction which sets a value of the branch flag dependent on whether the value in that register exceeds or is smaller than another value. In some configurations the predetermined condition is satisfied if the data value in the register is used in the comparison instruction without being otherwise altered. In some configurations the predetermined condition is satisfied if the data value is either unmodified or is modified by a predefined subset of instructions.

In some configurations the one or more tracking operations comprises monitoring data values stored at monitored addresses identified from one or more previously observed addresses specified by the load instruction. In other words, whilst the load instruction may load data from a single fixed location (a single fixed monitoring address), this does not have to be the case. Rather, the address from which the load instruction retrieves the data may vary for different instances of the load instruction. For example, the load instruction, along with the subsequent data dependent occurrence of the branch instruction, may be comprised in a loop or function that is frequently called during program execution. On each iteration of that loop, a different address may be provided as an input argument for the load instruction. The control circuitry may therefore identify a sequence of previously observed addresses and identify, from that sequence, a monitored address (or monitored addresses) to be monitored in order to identify the data value(s) stored at the monitored address(es) and to predict a next data dependent occurrence of the branch condition.

In some configurations the one or more tracking operations comprises monitoring access requests specifying the monitored addresses. In other words, the pre-computation circuitry determines when either a load or a store request to the monitored addresses is issued, e.g., by fetch circuitry or prefetch circuitry comprised in the apparatus, and tracks the data value at the monitored address. This approach avoids issuing additional load requests to retrieve data values from the monitored address(es) and allows the pre-computation circuitry to determine data stored at the monitored address(es) without having to burden the memory system with additional load requests. The pre-processing circuitry therefore tracks, for each monitored address, whether the current value of data stored at that monitored address would result in the data dependent occurrence of the branch instruction having a branch taken or a branch not taken outcome. The pre-processing circuitry is then able to perform a determination, in advance of the data dependent occurrence of the branch instruction what the expected outcome of the branch instruction would be.

In some configurations the one or more tracking operations comprises retrieving the data from the monitored addresses. The pre-computation circuitry may issue a read request specifying one of the monitored addresses to determine a value of the data at that monitored address. Such an approach allows the pre-computation circuitry to determine a current data value at the monitored address and can be useful in use cases where data stored at the monitored address is written or modified by processing circuitry other than the processing circuitry executing the branch instruction.

In some configuration the apparatus is provided with tracking circuitry configured to identify a pattern of the one or more previously observed addresses; and address prediction circuitry configured to predict, as the monitored addresses, one or more future addresses based on the pattern. In some configurations the monitored addresses may be the same as the previously stored addresses, for example, the monitored addresses may, in such cases, be determined based on observation of a repeating sequence of the one or more previously observed addresses address. However, in some configurations, the monitored addresses may be different from the one or more previously observed addresses and may be identified based on the pattern. The provision of tracking circuitry and address prediction circuitry allows an outcome of a greater range of data dependent occurrences of the branch prediction instruction to be predicted.

The address tracking circuitry may take any form. However, in some configurations the address tracking circuitry comprises stride identification circuitry configured to identify a stride length indicative of a distance in address space between sequential ones of the one or more previously observed addresses, and the pattern comprises an indication of the stride length. The stride prediction circuitry may comprise single stride prediction circuitry configured to track a single stride length between consecutive ones of the one or more addresses. Alternatively, or in addition, the stride prediction circuitry may be provided with more complex stride prediction circuitry capable of tracking variable stride lengths nested stride patterns.

In some configurations the address tracking circuitry comprises sequence recognition circuitry configured to identify a repeated observation of a same sequence of the previously observed addresses, and the pattern comprises an indication of the sequence. The sequence recognition circuitry may be configured to recognise any repeated sequence of addresses having a length less than or equal to a predefined sequence length. In some configurations, the sequence recognition circuitry may be combined with stride identification circuitry and may be capable of recognising repeated sequences of address where each sequence of addresses is separated by a given stride length.

In some configurations the load instruction is a consumer load instruction; and the address tracking circuitry comprises indirect address identification circuitry configured to track, as the one or more previously observed addresses, a sequence of producer addresses, each producer address of the sequence of producer addresses to be used as an operand in a producer load instruction resulting in a producer result value from which a consumer load address is derived, the consumer load address to be used in the consumer load instruction resulting in a consumer result value from which the data value is derived. In other words, the address tracking circuitry is configured to identify a producer-consumer relationship between monitored addresses where the outcome of the data dependent branch instruction is based on a consumer load instruction that loads a data value based on an address obtained from a producer load instruction. The addresses from which the consumer load instruction loads data values may not follow a recognisable pattern. However, the addresses from which the consumer load instruction loads the data values may be identifiable in advance because they are addresses loaded by a preceding producer load instruction where that producer load instruction loads data from addresses that follow a recognisable pattern, e.g., a pattern that may be recognisable by sequence recognition circuitry or stride identification circuitry.

In some configurations the apparatus comprises prefetch circuitry, wherein at least one portion of the address tracking circuitry or the address prediction circuitry is provided by the prefetch circuitry. The address tracking circuitry of the present techniques tracks addresses from which data is to be loaded, i.e., it identifies particular addresses that are predicted to store data values that will be required by the processing circuitry based, for example, on techniques of stride recognition, pattern recognition and/or indirect pattern recognition. This function may also be provided in the context of data prefetching circuitry provided to allow data items required by processing circuitry to be retrieved into local storage circuitry in advance of a demand request for that data item by processing circuitry. The use of existing prefetching circuitry to allow the pre-processing circuitry to identify monitored addresses allows for a more compact implementation reducing both circuit area and power requirements.

In some configurations the control circuitry is configured to determine that the predetermined condition is satisfied when a result of the load instruction is stored in a register and the condition is dependent on a comparison instruction specifying the register. The control circuitry may be configured to identify a dependency chain between each observed load instruction and a subsequent branch condition. For example, the control circuitry may identify a physical register into which data resulting from a load instruction is stored. The physical register may be marked with a tag indicating that the physical register stores a data value that has been loaded but is currently unaltered. The control circuitry may also store an indication of the load instruction (e.g., a program counter value associated with the load instruction, an indication of the address from which the data is loaded, and an indication of the physical register that the data loaded by that load instruction is stored). When a tagged physical register is then utilised as an operand for a comparison instruction that sets a conditional flag utilised by a subsequent branch instruction, the control circuitry can then recognise that the load instruction that output to that register is a load instruction that satisfies the predetermined condition. In some configurations the control circuitry may monitor the load instruction to identify a pattern of addresses associated with that load instruction in order to train the pre-computation circuitry to monitor the addresses associated with that load instruction in advance of the data dependent occurrence of the branch instruction.

Whilst the prediction circuitry may be the only prediction circuitry provided within the apparatus, in some configuration the apparatus comprises default branch prediction circuitry configured to perform a default prediction of whether the data dependent occurrence of the branch instruction is taken or not taken; and confidence circuitry configured to calculate a confidence level associated with the data dependent prediction, wherein: the prediction circuitry is configured to determine whether the confidence level satisfies a threshold condition; when the threshold condition is not satisfied, to determine the result of the branch instruction based on the default prediction; and when the threshold condition is satisfied, to override the default prediction and to determine the result of the branch instruction based on the data dependent prediction. The default branch prediction circuitry may be any form of branch prediction circuitry known to the person of ordinary skill in the art, for example, the branch prediction circuitry may comprise any type of static or dynamic branch prediction techniques include, for example, history dependent branch predictors, bimodal branch predictors, TAgged GEometric (TAGE) branch predictors, perceptron based predictors, and/or hybrid branch predictors. The apparatus may, as a default, use the default prediction structure to determine a predicted outcome of a branch instruction. The provision of the confidence calculation circuitry allows calculation of a confidence in the data dependent prediction over a number of iterations of the branch instruction. The confidence may be provided as a saturating counter that is incremented when, at a time of branch resolution, it is determined that the data dependent prediction is correct, and the confidence may be decremented when, at a time of branch resolution, it is determined that the data dependent prediction is incorrect. When the confidence satisfies a threshold condition the data dependent prediction may be used in place of the default prediction. The threshold condition may be statically defined, i.e., when the confidence exceeds a predetermined amount, the data dependent prediction is used regardless of a confidence in the default prediction. In some configurations, the threshold condition may be dependent on one or both a static threshold and a confidence in the default prediction. For example, the data dependent prediction may be used when the confidence in the data dependent condition both exceeds a static threshold and exceeds a confidence in the default prediction.

The data dependent prediction may be a single prediction associated with a next identified data dependent branch instruction. However, in some configurations the control circuitry is configured to identify when a predicted sequence of occurrences of the branch instruction are data dependent occurrences of the branch instruction; and the pre-computation circuitry is configured to generate a sequence of data dependent determinations of whether the condition associated with a subset of the sequence of data dependent occurrences of the branch instruction is satisfied, wherein the subset comprises data dependent occurrences between a current non-speculative point of execution to at least a current speculative point of execution. The predicted sequence of occurrences may therefore comprise a next occurrence of the data dependent branch instruction and one or more further occurrences of the data dependent branch instruction. In other words, the predicted sequence may comprise several predictions indicating expected outcomes of the data dependent branch instruction.

In some configurations the pre-computation circuitry is configured to track a current determination of the sequence of data dependent determinations and to perform N future determinations, where N is a positive integer. The greater the number of future determinations, the greater the number of blocks of instructions that can be speculatively retrieved resulting in improved performance of the processing circuitry and reduced latency associated with having to retrieve blocks of instructions at a time of execution of the branch instruction.

Whilst N may be a statically set parameter, in some configurations the pre-computation circuitry is configured to determine N based on at least one of: an accuracy of the sequence of data dependent determinations; and a number of cycles required by the pre-computation circuitry to perform each of the data dependent determinations. Predicting the outcome of the data dependent branch instructions further in advance can result in an improvement in the overall performance, e.g., because the required instructions following the data dependent occurrence of the branch prediction can be fetched in a timely manner, this also relies on the data values stored at the monitored addresses to be fixed further in advance of the occurrence of the data dependent occurrence of the branch instruction. For example, where the data values stored at the monitored location are determined in advance, then it may be possible to increase N and make a large number of predictions in advance. On the other hand, where the data values stored in the monitored locations are dynamically modified during execution of the sequence of instructions, it may be desirable to reduce N to ensure that the data values at the monitored locations do not change between a time of making the data dependent prediction and resolution of the branch instruction. The value of N may therefore be determined based on one or a combination of the accuracy of the sequence of data dependent determinations (e.g., a greater accuracy will cause N to increase and a lower accuracy will cause N to decrease), and the number of cycles required to perform the data dependent determinations (e.g., if the data dependent determination requires a large number of cycles, then N may be increased to ensure that the determinations are available in advance of the resolution of the branch instruction).

In some configurations the prediction circuitry is configured to trigger retrieval of one or more blocks of instructions in dependence on the outcome of the determination, the one or more blocks of instructions including a target instruction at the target address associated with the data dependent branch instruction. Retrieval of the one or more blocks of instructions in response to the data dependent predictions reduces the latency experienced by the processing circuitry when those instructions are required. For example, in absence of a prediction, or as a result of a miss prediction, the required blocks of instructions may not be readily available to the processing circuitry. The processing circuitry would then have to wait for the required blocks of instructions to be retrieved resulting in a stall. However, where an accurate prediction is provided, the blocks of instructions can be retrieved in advance removing the need for the processing circuitry to wait on retrieval of those instructions.

Particular configurations will now be described with reference to the figures.

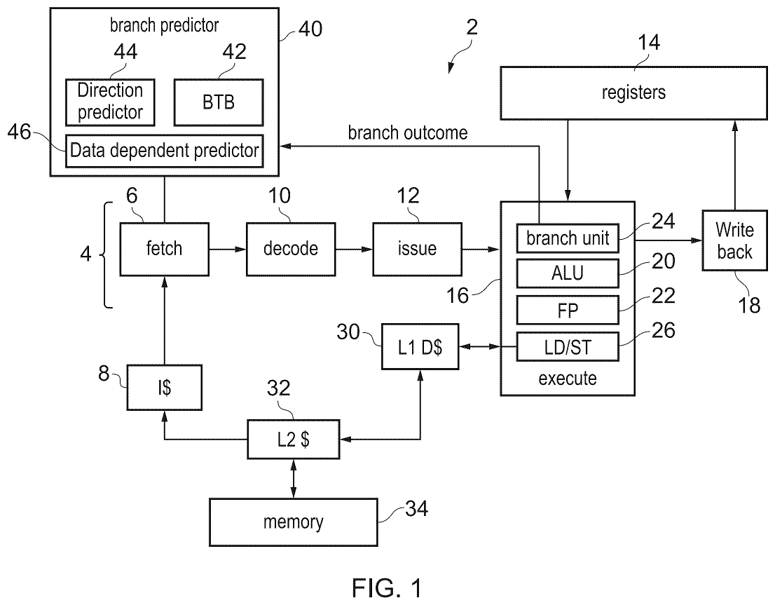

FIG. 1 schematically illustrates an example of a data processing apparatus 2. The data processing apparatus has a processing pipeline 4 which includes a number of pipeline stages. In this example, the pipeline stages include a fetch stage 6 for fetching instructions from an instruction cache 8; a decode stage 10 for decoding the fetched program instructions to generate micro-operations to be processed by remaining stages of the pipeline; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture, and other systems may have additional stages or a different configuration of stages. For example, in an out-of-order processor a register renaming stage could be included for mapping architectural registers specified by program instructions or micro-operations to physical register specifiers identifying physical registers in the register file 14.

The execute stage 16 includes a number of processing units, for executing different classes of processing operation. For example the execution units may include a scalar arithmetic/logic unit (ALU) 20 for performing arithmetic or logical operations on scalar operands read from the registers 14; a floating point unit 22 for performing operations on floating-point values; a branch unit 24 for evaluating the outcome of branch operations and adjusting the program counter which represents the current point of execution accordingly; and a load/store unit 28 for performing load/store operations to access data in a memory system 8, 30, 32, 34.

In this example, the memory system includes a level one data cache 30, a level one instruction cache 8, a shared level two cache 32 and main system memory 34. It will be appreciated that this is just one example of a possible memory hierarchy and other arrangements of caches can be provided. The specific types of processing unit 20 to 26 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness.

As shown in FIG. 1, the apparatus 2 includes a branch predictor 40 for predicting outcomes of branch instructions. The branch predictor is looked up based on addresses of instructions provided by the fetch stage 6 and provides a prediction on whether those instructions are predicted to include branch instructions, and for any predicted branch instructions, a prediction of their branch properties such as a branch type, branch target address and branch direction (predicted branch outcome, indicating whether the branch is predicted to be taken or not taken). The branch predictor 40 includes a branch target buffer (BTB) 42 for predicting properties of the branches other than branch direction, and a branch direction predictor (BDP) 44 for predicting the not taken/taken outcome (branch direction). The branch predictor 40 is provided with data dependent branch predictor circuitry 46 configured to identify occurrences of branch prediction instructions in which the condition associated with the branch instruction has a dependency on a data value, and where the dependency satisfies a predetermined condition. The data dependent branch predictor 46 is configured to generate a data dependent prediction based on monitoring of data values to determine, in advance of execution of the branch instruction, whether the branch instruction is expected to result in a taken or a not-taken outcome based on the monitored data values. It will be appreciated that the branch predictor could also include other prediction structures such as a call-return stack for predicting return addresses of function calls, a loop direction predictor for predicting when a loop controlling instruction will terminate a loop, or other more specialised types of branch prediction structures for predicting behaviour of outcomes in specific scenarios.

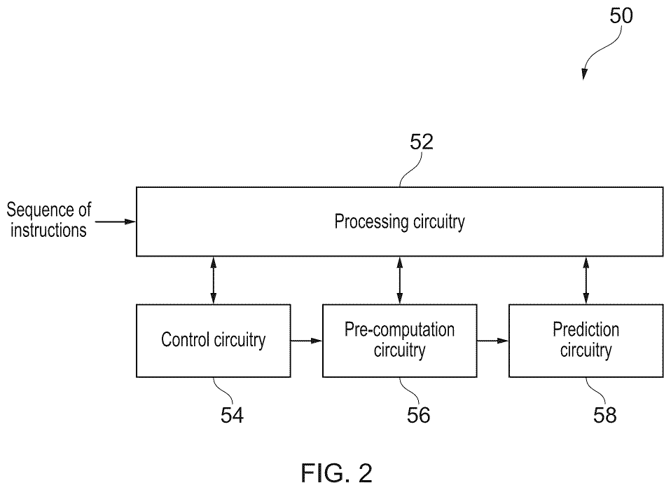

FIG. 2 schematically illustrates an apparatus 50 according to some configurations of the present techniques. The apparatus 50 comprises processing circuitry 52, control circuitry 54, pre-computation circuitry 56, and prediction circuitry 58. The processing circuitry 52 receives a sequence of instructions and performs processing operations in response to the received sequence of instructions. The processing circuitry 52 is responsive to receipt of a branch instruction to trigger a non-sequential change in the processing operations to an instruction at a target address. The target address may, for example, be defined in the branch instruction. The control circuitry 54 is configured to identify when an occurrence of a branch instruction is a data dependent occurrence of the branch instruction in which the dependency of the branch instruction on a data value satisfies a predetermined condition. The pre-computation circuitry 56 is arranged to perform tracking operations to track the data value in order to determine whether a data dependent occurrence of the branch instruction will be taken or not taken in advance of execution of the branch instruction. The prediction circuitry 58 is responsive to the determination, performed by the pre-computation circuitry 56, to perform a data dependent prediction of the outcome of the branch instruction in dependence on the determination.

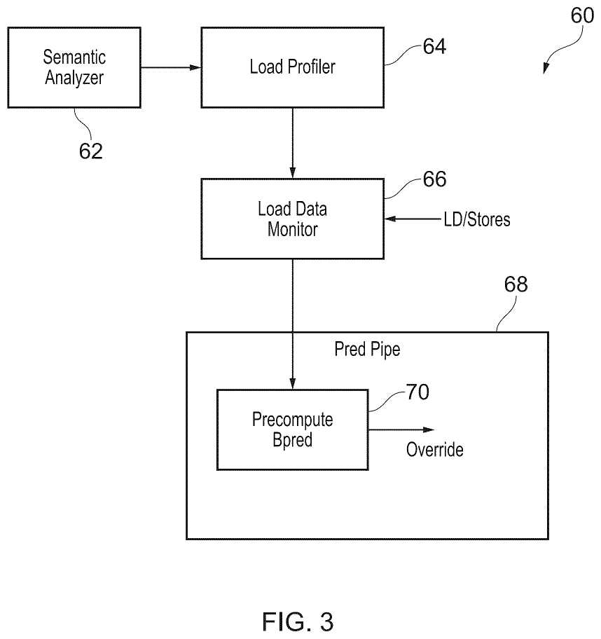

FIG. 3 schematically illustrates an apparatus 60 according to some configurations of the present techniques. The apparatus 60 is configured to base data dependent predictions on a data value that is loaded repeatedly from a same address, i.e., so that only a single address needs to be tracked. The apparatus 60 comprises a semantic analyser 62, a load profiler 64, a load data monitor 66, and a prediction pipeline 68.

The semantic analyser 62 may be preconfigured to identify one or more particular relationships between a load instruction and a comparison instruction on which a branch is based. For example, the semantic analyser 62 may analyse instructions from a block of instructions (or from a sequence of blocks of instructions) during execution of those instructions to identify an occurrence of a load instruction that outputs data to a register. The semantic analyser may store details of the load instruction, for example, a record of the instruction and its operands, or an indication of a program counter value of the load instruction. The semantic analyser may also track the register to which the data was output, this may be achieved either by storing an indication of a register identifier or by marking the register with a particular tag bit. The semantic analyser 62 may also analyse the block of instructions (of blocks of instructions) for a branch instruction an instruction (either the branch instruction itself or a separate instruction preceding the branch instruction) that sets a conditional flag on which the branch instruction is based. On identification of such an instruction, the semantic analyser 62 may determine register operands on which the comparison is based. The semantic analyser 62 may perform a lookup to determine if the register on which the comparison is based is a register to which a data value was stored subsequent to a load instruction. In some cases, the register identification may be performed based on physical registers. Where the same physical register is used for a result of a load instruction and, subsequently, as an input to a comparison operation, the semantic analyser 62 may identify that a branch condition based on that comparison is a data dependent branch instruction having a data dependency that meets the predetermined condition. In some configurations, the semantic analyser may also recognise dependencies in which one or more of a limited subset of instructions modify the data value resulting from the load instruction prior to that data value being used in the conditional instruction. Once the semantic analyser 62 has identified a data dependent load instruction having a data dependency that satisfies the predetermined condition, the semantic analyser 62 passes the data dependency to the load profiler.

The load profiler 64 receives, from the semantic analyser 62, an indication of a data dependent branch instruction having a data dependency that satisfies the predetermined condition. The received information comprises sufficient information to identify the load instruction, for example, a program counter value of the load instruction. The load profiler 64 then determines whether the load address, i.e., the address from which the load instruction retrieves data, is predictable. In the current configuration, the load profiler 64 identifies whether the data is loaded from a single address. This may be achieved, for example, by identifying that a same address is used on two or more consecutive instances of that load instruction.

If the load address is determined to be predictable, then an indication of the load address is passed from the load profiler 64 to the load data monitor 66 (an example of pre-computation circuitry) which tracks a current version of the data stored at the load address. This is achieved by monitoring load/store transactions targeting the load address. The load data monitor 66 may respond to a store instruction targeting the load address by updating a locally stored version of the data value based on the data to be stored at the load address. The load data monitor 66 may respond to a load instruction targeting the load address by updating the locally stored data value to the data retrieved from the load address.

The data values stored at the load address are then passed to the prediction pipeline 68 along with an indication of the conditional relationship to allow the prediction pipeline 68 to generate a data dependent branch prediction 70 based on those data values and the conditional relationship. The data dependent branch prediction 70 may overwrite a default history based branch prediction in the event that a confidence associated with the data dependent branch prediction is sufficiently high.

Operation of the apparatus 60 is now described through a sequence of illustrative examples. As a first example, the processing circuitry may receive the following sequence of instructions:
LDR w10[x0 #0];
CMP w10 #1;
BLT 0x420128;
   The first instruction, LDR, is a load instruction specifying a target register, in this example use case, w10, and specifying registers (x0 and the modifier #0 which is specified as an immediate value) from which the load address is to be generated. The second instruction, CMP, compares the data value stored in w10 against the immediate values #1 and sets a conditional flags based on the result of that comparison. The third instruction causes a branch to the address 0x420128 (the target address) when the conditional flags indicate that, based on the CMP instruction, w10 is less than #1 and, otherwise, to continue execution of the next sequential instruction. In the illustrated sequence, the branch will therefore be taken or not taken dependent on the data value loaded from the address generated based on x0 and the immediate value #0. As discussed, and based on the above sequence of instructions, the semantic analyser will identify that there is a direct dependency of the branch instruction and the data value that is loaded through the comparison instruction. In particular, the semantic analyser identifies that the LDR instruction outputs to register w10 which is then subsequently used in the comparison instruction CMP without the value stored in w10 being modified between those instructions. The semantic analyser 62 passes an indication of this dependency, specifying a program counter value of the LDR instruction, to the load profiler 64 which then identifies a pattern of addresses from which the data value to be stored in w10 is loaded. In the illustrated configuration, the load profiler identifies sequential occurrences of the LDR instruction (e.g., by observing the address resolved by a load/store unit in response to receiving the load instruction at the program counter value indicated by the semantic analyser. In the example of FIG. 3, the load profiler is arranged to identify cases in which the same load address is used for consecutive occurrences of the load instruction. Assuming a same address is identified, the address, generated from x0 and the immediate value, e.g., by adding data values in x0 and #0, will be passed to the load data monitor 66 to monitor the data values stored at that address in order to predict an outcome of the branch instruction in advance of the branch instruction being executed.

As a second example, the CMP and BLT instructions may be replaced by a single compare and branch instruction, for example;
LDR w10[x0 #0];
CBNZ w10 0x4020a8;
   Here the CBNZ instruction replaces the CMP and the BLT instruction. CBNZ is a compare and branch on nonzero instruction that combines the comparison instruction and the branch instruction into a single instruction. The CBNZ instruction compares the value stored in w10 to zero and branches if w10 is nonzero. Based on the above sequence of instructions the semantic analyser will identify that there is a direct dependency of the branch instruction and the data value that is loaded through the comparison instruction and this will be passed to the semantic analyser which proceeds to identify the loaded addresses as in the first example.

As a third example, the processing circuitry may receive a set of instructions in which there is one or more instructions which modify the data resulting from the load instruction before a determination is made as to whether a branch will be taken. For example, the processing circuitry may receive the following set of instructions:
LDR x14[x0 #0];
LSR x15 x14 #32;
CBNZ x15 0x40c97c;
   In the third example, the right shift instruction, LSR (Logical Shift Right), is provided to modify the data loaded into the register x14 by shifting it to the right by a number of places indicated by the immediate value. In this case, the data is right shifted by 32 places. The branch instruction is then based on the result of the LSR which is stored in x15. Based on the above sequence of instructions the semantic analyser will identify that there is a dependency of the branch instruction and the data value that is loaded and modified by the LSR instruction through the comparison instruction and this will be passed to the semantic analyser which proceeds to identify the loaded addresses as in the first example.

It will be readily apparent to the skilled person that the above example sets of instructions are provided as illustrative examples, and that the semantic analyser may be defined such that it can identify a range of different relationships between the load instruction and the outcome of the branch instruction.

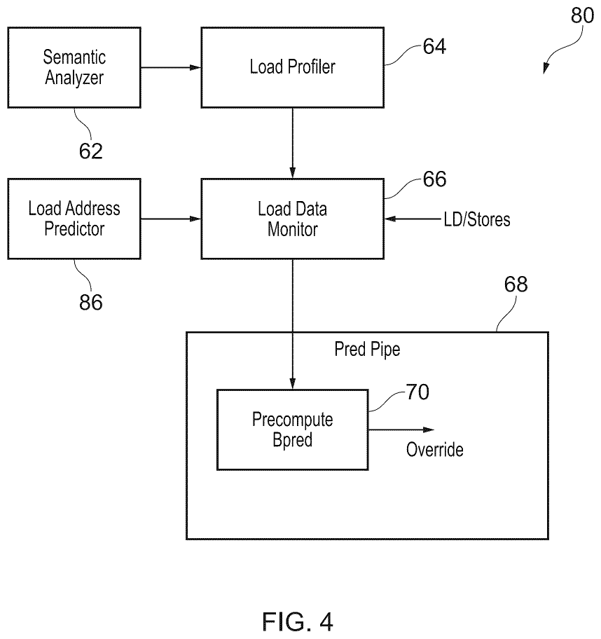

Whilst, in the above configuration, the identification of data values was dependent on the load profiler identifying a same address from which the data value used to determine the branch was loaded, this does not have to be the case. FIG. 4 schematically illustrates an apparatus 80 according to some configurations of the present techniques. The apparatus 80 comprises the same blocks as described in relation to FIG. 3. However, in addition to the semantic analyser 62, the load profiler 64, the load data monitor 66, and the prediction pipeline 68, the apparatus 80 is also provided with a load address predictor 86 that is coupled to the load data monitor 66. The load address predictor may be any form of prediction circuitry that is configured to predict a sequence of addresses used to generate the data values used for the load instruction. For example, in the above illustrative examples, if the addresses used in the load instruction-LDR x14 [x0 #0]—followed a repeated pattern having a limited number of unique addresses, e.g., [ADDRESS 1], [ADDRESS 2], [ADDRESS 3], and [ADDRESS 4] being repeated, then the apparatus 80 may be able to identify and monitor data values at those addresses in order to identify, for a given instance of the data dependent occurrence of the branch instruction, which address is going to be used for that load instruction. The load data monitor 66 monitors all addresses, e.g., [ADDRESS 1], [ADDRESS 2], [ADDRESS 3], and [ADDRESS 4] and keeps an up to date copy of the data stored at each of those addresses. The load data monitor 66 can then, based on the identified instance of the branch instruction predicted by the load address predictor 86, pass a data value that is appropriate to the particular instance of the branch instruction to the prediction pipeline 68 which then proceeds to predict the outcome of the branch instruction based on that data value.

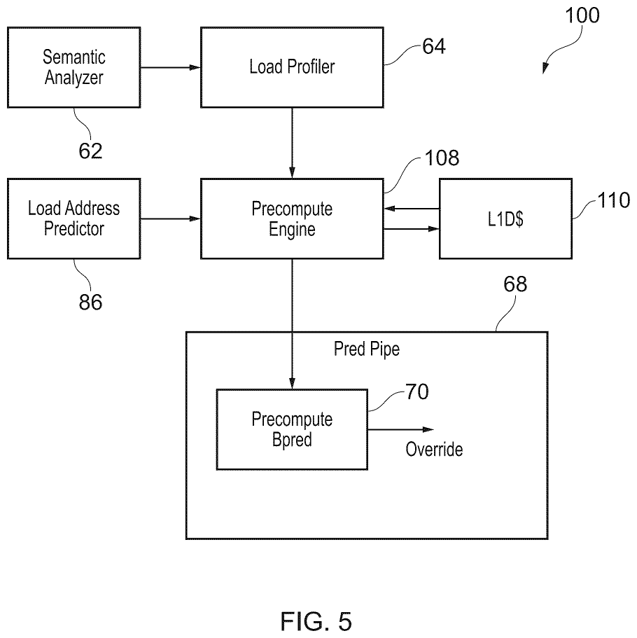

FIG. 5 schematically illustrates an apparatus 100 according to some configurations of the present techniques. The apparatus 100 comprises a number of the same blocks as described in relation to FIG. 4. However, in the apparatus 100, the load data monitor 66, as described in relation to FIG. 4, is replaced with precompute engine 108 which is coupled to the L1 data cache 110. In the illustrated example, the load profiler 64 is configured to identify more complex patterns. For example, the load profiler 64 may identify a strided sequence of addresses which may have a single stride length, or multiple nested or sequential stride lengths. The load profiler may also be configured to identify producer-consumer relationships associated with the load instruction, e.g., that the address resolved on execution of the load instruction is generated from a preceding producer load instruction, the preceding producer load instruction having an identifiable sequence of addresses. The load profiler 64 passes an indication of the load instruction to the precompute engine 108. The load address predictor 86 uses an indication of the predicted sequence of addresses to predict the addresses that may be required for those load instructions, e.g., according to an identified stride sequence. The precompute engine 108 interfaces with the L1 data cache 110 to identify the data values at the sequence of addresses. In other words, the precompute engine 108 receives an indication of the load instruction from the load profiler 64 and an indication of the address from which data is to be loaded from the load address predictor 86 and requests the data from that load address from the L1 data cache 110. The data is returned by the L1 data cache 110 to the precompute engine 108. The precompute engine may also receive an indication of any intervening instructions, i.e., any modifications that are made to the received data in order to predict whether the branch instruction identified by the semantic analyser 62 is taken or not taken. The precompute engine may perform processing to determine whether the branch is taken or not taken and pass the data dependent branch prediction 70 to the prediction pipeline 68 which will determine whether or not to use the data dependent branch prediction or a default prediction (e.g., determined based on a branch history) based on a confidence level associated with the data dependent branch prediction.

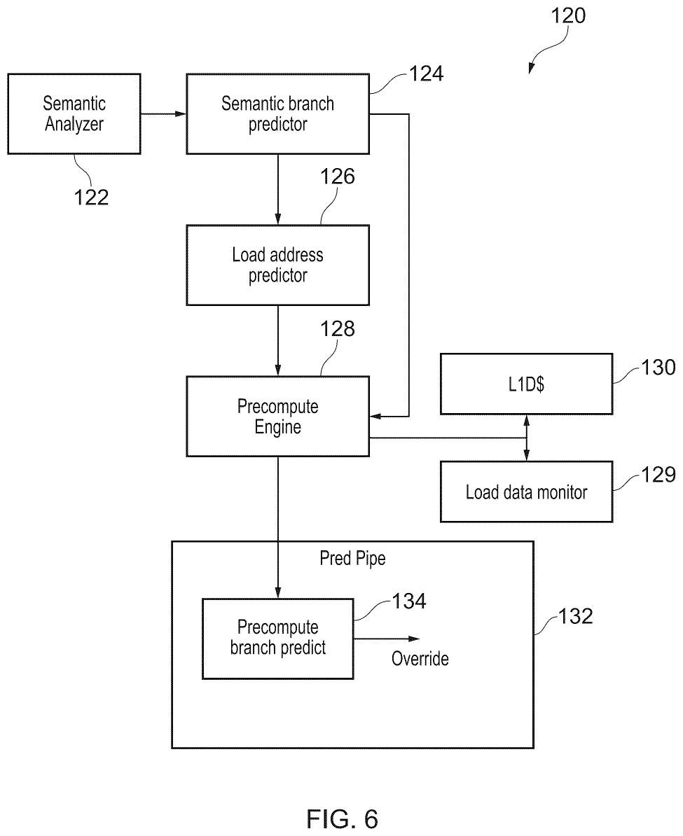

FIG. 6 schematically illustrates details of an apparatus 120 according to some configurations of the present techniques. The apparatus comprises a semantic analyser 122 to identify data dependent occurrences of a branch prediction instruction in which a data dependency of the branch prediction instruction satisfies a predetermined condition. The semantic analyser 122 passes details of the branch instruction having a data dependency satisfying the predetermined condition to the semantic branch prediction circuitry 124. The semantic branch predictor circuitry 124 stores a plurality of branch prediction entries, i.e., a plurality of entries each identifying a load instruction, a corresponding branch prediction instruction that has been identified to be dependent on that load instruction, and any intervening data dependencies that have been identified as modifying the loaded value in order to determine whether the branch is taken or not taken. The semantic branch prediction circuitry 124 provides an indication of the load instructions to the load address prediction circuitry 126 which is configured to predict addresses associated with each of the entries store din the semantic branch predictor circuitry 124. The load address predictor 126 may predict addresses for one or plural of the entries at any given time. The predicted addresses, or an indication of the address patterns to be used to predict the addresses, are passed from the load address predictor 126 to the precompute engine 128. In addition, information on the entries is passed from the semantic branch predictor 124 to the precompute engine 128. For example, data identifying a relationship between the loaded data and whether the branch is taken or not taken may be passed from the semantic branch predictor 124 to the precompute engine 128. The precompute engine is therefore provided with an indication of where the data values are stored and an indication of how the branch result depends on those data dependencies. The precompute engine 128 interacts with the L1 data cache 130 and the load data monitor 129 to identify an up to date copy of the data value(s) on which the branch will depend. The precompute engine 128 then determines, for a given instance of a branch instruction that has been identified in one of the entries stored in the semantic branch predictor 124, whether that branch instruction will be taken or not taken. The data dependent branch prediction 134 is then passed to the prediction pipeline 132 as described above.

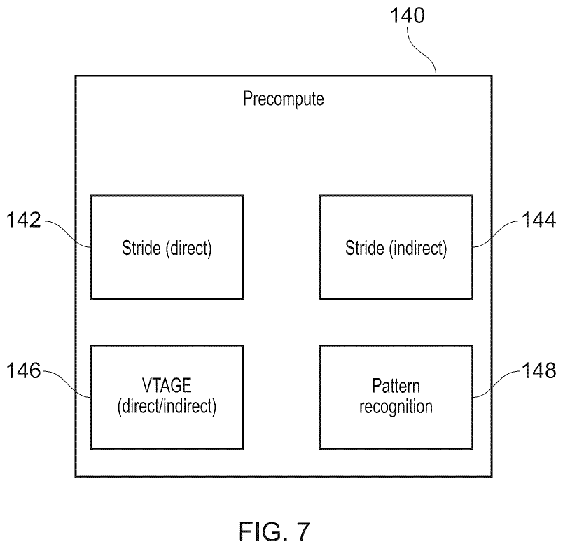

FIG. 7 schematically illustrates an example of precompute circuitry 140 configured to identify the addresses used in the data dependent occurrences of the branch instruction. The precompute circuitry 140 is provided with a range of different types of address prediction circuitry including direct stride prediction circuitry 142, indirect stride prediction circuitry 144, VTAGE prediction circuitry 146 and pattern recognition circuitry 148. The precompute circuitry 140 may be provided as dedicated circuitry. Alternatively, in some configurations the precompute circuitry 140 may be provided as part of prefetch circuitry configured to identify address patterns to prefetch data. This circuitry may be partially repurposed to identify data at addresses for branch prediction. It will be readily apparent to the skilled person that in alternative configurations, the precompute circuitry may comprise only one or a subset of the address prediction circuits. Alternatively, one or more additional types of address prediction circuitry may be provided in addition to, or as an alternative to one or more of the types of address prediction circuitry illustrated in FIG. 7.

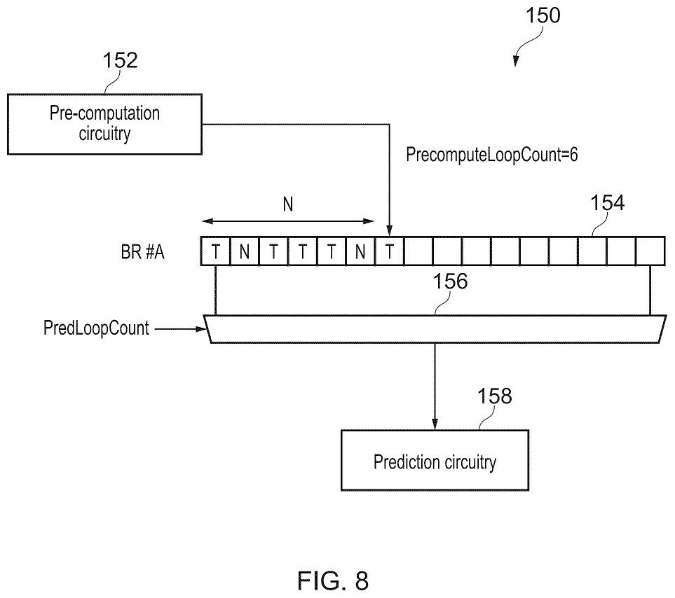

FIG. 8 schematically illustrates a sequence of predictions 154 provided by pre-computation circuitry 152 according to some configurations of the present techniques. The pre-computation circuitry 152 may be capable of predicting a sequence of N predictions 154 as to whether a particular branch instruction is taken (T) or non-taken (N). In general, the further ahead the pre-computation circuitry 152 predicts, the greater the likelihood that the data values stored at the identified addresses could change prior to execution of the branch instruction. On the other hand, the shorter the time (e.g., measured in clock cycles) between the prediction and the execution of the branch instruction, the greater the likelihood that there will be some additional latency resulting from fetching instructions resulting from the branch instruction. The pre-computation circuitry generates the N predictions 154 and tracks a current prediction that is to be passed to the prediction circuitry 158 using selection circuitry 156. Once the prediction is made, the predictions are retained until the branch instruction is resolved so that, in the event of a pipeline flush, the predictions can be re-used. The determination of how far ahead to predict, i.e., the value of N, may be based on a number of factors. For example, the number of predictions N may be the minimum N required to avoid latency associated with retrieving the required instructions from affecting processing. In some configurations, an upper limit may be set on N. For example, if only a single address is being used and a data value at that address is updated shortly before the data is loaded, then it may not be possible to use a large N, because the data values will not be ready that far in advance. Similarly, if the address is one of a limited set of addresses, e.g., M addresses, then N may be bounded from above by M.

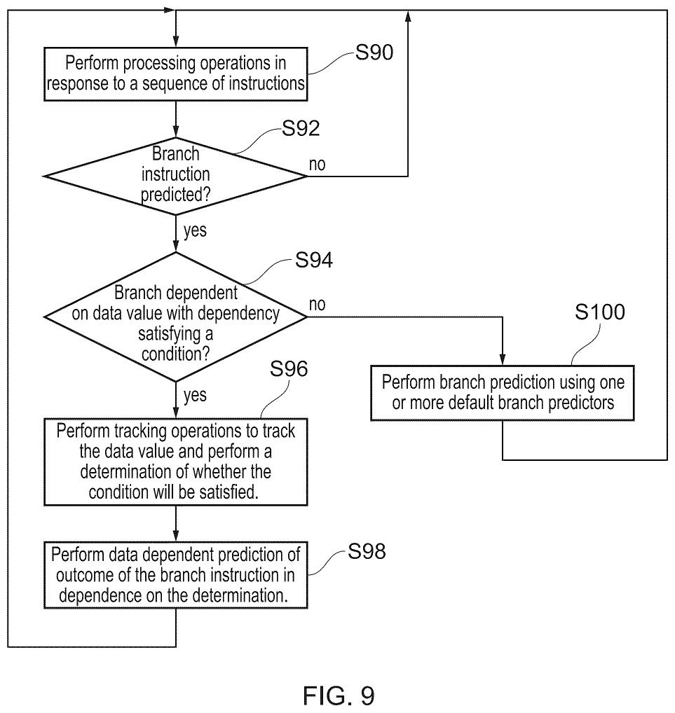

FIG. 9 schematically illustrate a sequence of steps carried out by an apparatus according to some configurations of the present techniques. Flow begins at step S90 where processing circuitry performs processing operations in response to a sequence of instructions. Flow then proceeds to step S92 where it is determined if a branch instruction is predicted. If, at step S92, it is determined that a branch instruction is not predicted, then flow returns to step S90. If, at step S92, it is determined that a branch instruction is predicted, then flow proceeds to step S94 where it is determined if the branch instruction is dependent on a data value where the dependency satisfies a predetermined condition. If, at step S94, it is determined that the branch instruction is dependent on a data value with a dependency satisfying a predetermined condition, then flow proceeds to step S96. At step S96, tracking operations are performed to track the data value and a determination is performed as to whether the condition will be satisfied. Flow then proceeds to step S98. At step S98 a data dependent branch prediction of an outcome of the branch instruction is performed in dependence on the determination before flow returns to step S90. If, at step S94, it was determined that the branch does not have a data dependency satisfying the predetermined condition, then flow proceeds to step S100 where a branch prediction using one or more default branch predictors is performed. Flow then returns to step S90.

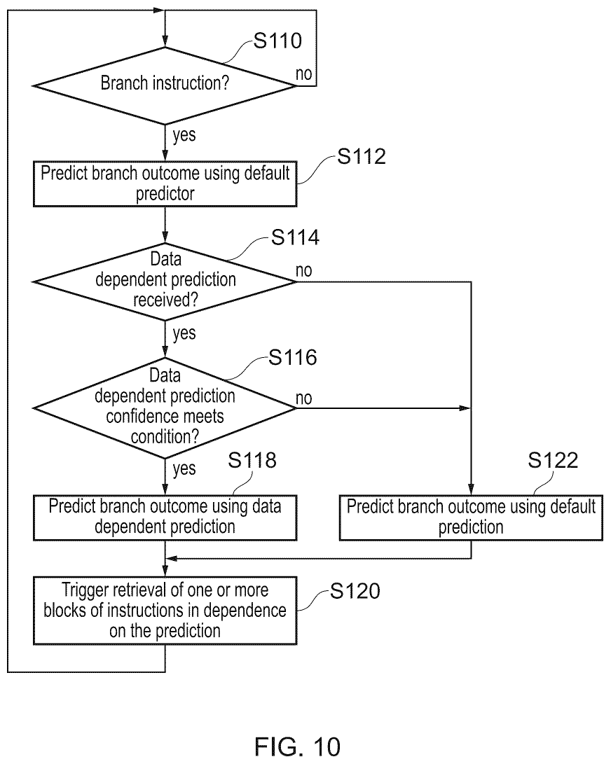

FIG. 10 schematically illustrates a sequence of steps carried out according to some configurations of the present techniques. Flow begins at step S110 where it is determined if a branch instruction is identified. If, at step S110 it is determined that a branch instruction is not identified, then flow remains at step S110. If, at step S110, it is determined that a branch instruction is identified, then flow proceeds to step S112 where the branch outcome is predicted using a default branch predictor. Flow then proceeds to step S114. At step S114, it is determined if a data dependent branch prediction has also been received. If, at step S114, it is determined that no data dependent branch prediction has been received, then flow proceeds to step S122 where the outcome of the branch instruction is predicted using the default prediction before flow proceeds to step S120. If, at step S114, it was determined that a data dependent prediction was received, then flow proceeds to step S116. At step S116 it is determined if the data dependent prediction confidence meets a condition, e.g., if the confidence exceeds a confidence threshold. If, at step S116, it is determined that the data dependent branch condition does not meet the condition, then flow proceeds to step S122. If, at step S116, it is determined that the data dependent prediction meets the confidence condition, then flow proceeds to step S118. At step S118, the branch outcome is predicted using the data dependent prediction before flow proceeds to step S120. At step S120, the retrieval of one or more blocks of instructions is triggered in dependence on the prediction before flow returns to step S110.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

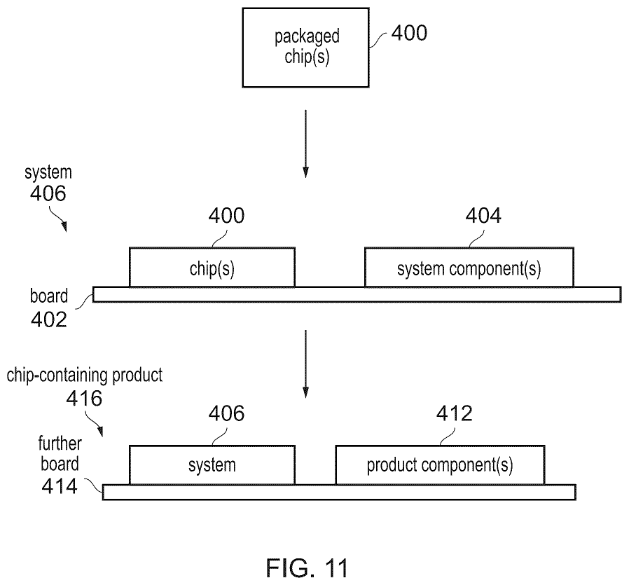

As shown in FIG. 11, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc. ; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In brief overall summary there is provided an apparatus comprising processing circuitry to perform processing operations. The processing circuitry is responsive to a branch instruction to determine whether a condition associated with the branch instruction is satisfied and, if so, to trigger a non-sequential change in the processing operations to an instruction at a target address. The apparatus is provided with control circuitry to identify when an occurrence of the branch instruction is a data dependent occurrence in which the condition has a dependency on a data value, the dependency satisfying a predetermined condition. The apparatus is provided with pre-computation circuitry to perform tracking operations to track the data value and to perform a determination, in advance of execution of the branch instruction, of whether the condition will be satisfied. The apparatus is provided with prediction circuitry to perform a data dependent prediction of an outcome of the branch instruction in dependence on the determination.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative configurations of the invention have been described in detail herein with reference to the accompanying drawings, it is to be understood that the invention is not limited to those precise configurations, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

Some configurations of the present techniques are described by the following numbered clauses:
Clause 1. An apparatus comprising:
   processing circuitry configured to perform processing operations in response to a sequence of instructions, wherein the processing circuitry is responsive to a branch instruction to determine whether a condition associated with the branch instruction is satisfied and, in response to the condition being satisfied, to trigger a non-sequential change in the processing operations to an instruction at a target address;
   control circuitry configured to identify when an occurrence of the branch instruction is a data dependent occurrence of the branch instruction in which the condition has a dependency on a data value, the dependency satisfying a predetermined condition;
   pre-computation circuitry configured to perform one or more tracking operations to track the data value and to perform a determination, in advance of execution of the branch instruction, of whether the condition will be satisfied; and
   prediction circuitry configured to perform a data dependent prediction of an outcome of the branch instruction in dependence on the determination.
Clause 2. The apparatus of clause 1, wherein the control circuitry is configured to identify that the predetermined condition is satisfied based on an observation that the data value is dependent on a load instruction preceding the data dependent occurrence of the branch instruction.
Clause 3. The apparatus of clause 2, wherein the one or more tracking operations comprises monitoring data values stored at monitored addresses identified from one or more previously observed addresses specified by the load instruction.
Clause 4. The apparatus of clause 3, wherein the one or more tracking operations comprises monitoring access requests specifying the monitored addresses.
Clause 5. The apparatus of clause 3 or clause 4, wherein the one or more tracking operations comprises retrieving the data from the monitored addresses.
Clause 6. The apparatus of any of clauses 3 to 5, comprising:
   address tracking circuitry configured to identify a pattern of the one or more previously observed addresses; and
   address prediction circuitry configured to predict, as the monitored addresses, one or more future addresses based on the pattern.
Clause 7. The apparatus of clause 6, wherein the address tracking circuitry comprises stride identification circuitry configured to identify a stride length indicative of a distance in address space between sequential ones of the one or more previously observed addresses, and the pattern comprises an indication of the stride length.
Clause 8. The apparatus of clause 6 or clause 7, wherein the address tracking circuitry comprises sequence recognition circuitry configured to identify a repeated observation of a same sequence of the previously observed addresses, and the pattern comprises an indication of the sequence.
Clause 9. The apparatus of any of clause 6 to clause 8, wherein:
   the load instruction is a consumer load instruction; and
   the address tracking circuitry comprises indirect address identification circuitry configured to track, as the one or more previously observed addresses, a sequence of producer addresses, each producer address of the sequence of producer addresses to be used as an operand in a producer load instruction resulting in a producer result value from which a consumer load address is derived, the consumer load address to be used in the consumer load instruction resulting in a consumer result value from which the data value is derived.
Clause 10. The apparatus of any of clauses 6 to 9, comprising prefetch circuitry, wherein at least one portion of the address tracking circuitry or the address prediction circuitry is provided by the prefetch circuitry.
Clause 11. The apparatus of any of clauses 2 to 10, wherein the control circuitry is configured to determine that the predetermined condition is satisfied when a result of the load instruction is stored in a register and the condition is dependent on a comparison instruction specifying the register.
Clause 12. The apparatus of any preceding clause, comprising:
   default branch prediction circuitry configured to perform a default prediction of whether the data dependent occurrence of the branch instruction is taken or not taken; and
   confidence circuitry configured to calculate a confidence level associated with the data dependent prediction,
   wherein:
   the prediction circuitry is configured to determine whether the confidence level satisfies a threshold condition;
   when the threshold condition is not satisfied, to determine the result of the branch instruction based on the default prediction; and
   when the threshold condition is satisfied, to override the default prediction and to determine the result of the branch instruction based on the data dependent prediction.
Clause 13. The apparatus of any preceding clause, wherein:
   the control circuitry is configured to identify when a predicted sequence of occurrences of the branch instruction are data dependent occurrences of the branch instruction; and
   the pre-computation circuitry is configured to generate a sequence of data dependent determinations of whether the condition associated with a subset of the sequence of data dependent occurrences of the branch instruction is satisfied, wherein the subset comprises data dependent occurrences between a current non-speculative point of execution to at least a current speculative point of execution.
Clause 14. The apparatus of clause 13, wherein the pre-computation circuitry is configured to track a current determination of the sequence of data dependent determinations and to perform N future determinations, where N is a positive integer.
Clause 15. The apparatus of clause 14, wherein the pre-computation circuitry is configured to determine N based on at least one of:
   an accuracy of the sequence of data dependent determinations; and
   a number of cycles required by the pre-computation circuitry to perform each of the data dependent determinations.
Clause 16. The apparatus of any preceding clause, wherein the prediction circuitry is configured to trigger retrieval of one or more blocks of instructions in dependence on the outcome of the determination, the one or more blocks of instructions including a target instruction at the target address associated with the data dependent branch instruction.
Clause 17. A system comprising:
   the apparatus of any preceding clause, implemented in at least one packaged chip;
   at least one system component; and
   a board,
   wherein the at least one packaged chip and the at least one system component are assembled on the board.
Clause 18. A chip-containing product comprising the system of clause 17, wherein the system is assembled on a further board with at least one other product component.
Clause 19. A method comprising:
   performing processing operations in response to a sequence of instructions;
   in response to a branch instruction, determining whether a condition associated with the branch instruction is satisfied;
   in response to the condition being satisfied, triggering a non-sequential change in the processing operations to an instruction at a target address;
   identifying when an occurrence of the branch instruction a data dependent occurrence of the branch instruction in which the condition has a dependency on a data value, the dependency satisfying a predetermined condition;
   performing one or more tracking operations to track the data value and performing a determination, in advance of execution of the branch instruction, whether the condition will be satisfied; and
   performing a data dependent prediction of an outcome of the branch instruction in dependence on the determination.
Clause 20. A non-transitory computer-readable medium storing computer-readable code for fabrication of the apparatus of any of clauses 1 to 18.

We claim:

1. An apparatus comprising:
processing circuitry configured to perform processing operations in response to a sequence of instructions, wherein the processing circuitry is responsive to a branch instruction to determine whether a condition associated with the branch instruction is satisfied and, in response to the condition being satisfied, to trigger a non-sequential change in the processing operations to an instruction at a target address;
control circuitry configured to identify when an occurrence of the branch instruction is a data dependent occurrence of the branch instruction in which the condition has a dependency on a data value, the dependency satisfying a predetermined condition;
pre-computation circuitry configured to perform one or more tracking operations to track the data value and to perform a determination, in advance of execution of the branch instruction, of whether the condition will be satisfied; and
prediction circuitry configured to perform a data dependent prediction of an outcome of the branch instruction in dependence on the determination.

2. The apparatus of claim 1, wherein the control circuitry is configured to identify that the predetermined condition is satisfied based on an observation that the data value is dependent on a load instruction preceding the data dependent occurrence of the branch instruction.

3. The apparatus of claim 2, wherein the one or more tracking operations comprises monitoring data values stored at monitored addresses identified from one or more previously observed addresses specified by the load instruction.

4. The apparatus of claim 3, wherein the one or more tracking operations comprises monitoring access requests specifying the monitored addresses.

5. The apparatus of claim 3, wherein the one or more tracking operations comprises retrieving the data from the one or more monitored addresses.

6. The apparatus of claim 3, comprising:
address tracking circuitry configured to identify a pattern of the one or more previously observed addresses; and
address prediction circuitry configured to predict, as the monitored addresses, one or more future addresses based on the pattern.

7. The apparatus of claim 6, wherein the address tracking circuitry comprises stride identification circuitry configured to identify a stride length indicative of a distance in address space between sequential ones of the one or more previously observed addresses, and the pattern comprises an indication of the stride length.

8. The apparatus of claim 6, wherein the address tracking circuitry comprises sequence recognition circuitry configured to identify a repeated observation of a same sequence of the previously observed addresses, and the pattern comprises an indication of the sequence.

9. The apparatus of claim 6, wherein:
the load instruction is a consumer load instruction; and
the address tracking circuitry comprises indirect address identification circuitry configured to track, as the one or more previously observed addresses, a sequence of producer addresses, each producer address of the sequence of producer addresses to be used as an operand in a producer load instruction resulting in a producer result value from which a consumer load address is derived, the consumer load address to be used in the consumer load instruction resulting in a consumer result value from which the data value is derived.

10. The apparatus of claim 6, comprising prefetch circuitry, wherein at least one portion of the address tracking circuitry or the address prediction circuitry is provided by the prefetch circuitry.

11. The apparatus of claim 2, wherein the control circuitry is configured to determine that the predetermined condition is satisfied when a result of the load instruction is stored in a register and the condition is dependent on a comparison instruction specifying the register.

12. The apparatus of claim 1, comprising:
default branch prediction circuitry configured to perform a default prediction of whether the data dependent occurrence of the branch instruction is taken or not taken; and
confidence circuitry configured to calculate a confidence level associated with the data dependent prediction,
wherein:
the prediction circuitry is configured to determine whether the confidence level satisfies a threshold condition;
when the threshold condition is not satisfied, to determine the result of the branch instruction based on the default prediction; and
when the threshold condition is satisfied, to override the default prediction and to determine the result of the branch instruction based on the data dependent prediction.

13. The apparatus of claim 1, wherein:
the control circuitry is configured to identify when a predicted sequence of occurrences of the branch instruction are data dependent occurrences of the branch instruction; and
the pre-computation circuitry is configured to generate a sequence of data dependent determinations of whether the condition associated with a subset of the sequence of data dependent occurrences of the branch instruction is satisfied, wherein the subset comprises data dependent occurrences between a current non-speculative point of execution to at least a current speculative point of execution.

14. The apparatus of claim 13, wherein the pre-computation circuitry is configured to track a current determination of the sequence of data dependent determinations and to perform N future determinations, where N is a positive integer.

15. The apparatus of claim 14, wherein the pre-computation circuitry is configured to determine N based on at least one of:
an accuracy of the sequence of data dependent determinations; and
a number of cycles required by the pre-computation circuitry to perform each of the data dependent determinations.

16. The apparatus of claim 1, wherein the prediction circuitry is configured to trigger retrieval of one or more blocks of instructions in dependence on the outcome of the determination, the one or more blocks of instructions including a target instruction at the target address associated with the data dependent branch instruction.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A method comprising:
performing processing operations in response to a sequence of instructions;
in response to a branch instruction, determining whether a condition associated with the branch instruction is satisfied;
in response to the condition being satisfied, triggering a non-sequential change in the processing operations to an instruction at a target address;
identifying when an occurrence of the branch instruction a data dependent occurrence of the branch instruction in which the condition has a dependency on a data value, the dependency satisfying a predetermined condition;
performing one or more tracking operations to track the data value and performing a determination, in advance of execution of the branch instruction, whether the condition will be satisfied; and
performing a data dependent prediction of an outcome of the branch instruction in dependence on the determination.

20. A non-transitory computer-readable medium storing computer-readable code for fabrication of an apparatus comprising:
processing circuitry configured to perform processing operations in response to a sequence of instructions, wherein the processing circuitry is responsive to a branch instruction to determine whether a condition associated with the branch instruction is satisfied and, in response to the condition being satisfied, to trigger a non-sequential change in the processing operations to an instruction at a target address;
control circuitry configured to identify when an occurrence of the branch instruction is a data dependent occurrence of the branch instruction in which the condition has a dependency on a data value, the dependency satisfying a predetermined condition;
pre-computation circuitry configured to perform one or more tracking operations to track the data value and to perform a determination, in advance of execution of the branch instruction, of whether the condition will be satisfied; and
prediction circuitry configured to perform a data dependent prediction of an outcome of the branch instruction in dependence on the determination.
